(19) United States
(12) Patent Application Publication
(10) Pub. No.: US 2008/0310629 A1
(43) Pub. Date: Dec. 18, 2008

(54) Multibit Forensic Watermark with Encrypted Detection Key

(75) Inventors: Minne Van Der Veen, Eindhoven (NL); Aweke Negash Lemma, Eindhoven (NL); Mehmet Utku Celik, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Kpmomklijke Phillips Electroncis N.V., Eindhoven (NL)

(21) Appl. No.: 12/094,638

(22) PCT Filed: Nov. 10, 2006
(86) PCT No.: PCT/IB2006/054194

§ 371 Date: May 22, 2008

(30) Foreign Application Priority Data
Nov. 24, 2005 (EP) 05111234.0

(51) Int. Cl. G06T 1/00

(52) U.S. Cl. 380/201

(57) ABSTRACT

The invention relates to embedding auxiliary data in the form of a multibit payload in a host signal, and encrypting the associated detection key. Moreover, the invention relates to extracting the auxiliary data in the form of the multibit payload from a data signal. Auxiliary data is embedded in a host signal by the following steps. First a reference watermark is provided, subsequently an encrypted detection key associated only with the reference watermark is generated. The encrypted detection key may be a scrambled version of the watermark. In a further step, the multibit watermark is generated and a multibit payload is encoded into the reference watermark. Finally, the multibit watermark is embedded into the host signal.

### FIELD OF THE INVENTION

The invention relates to a method of embedding auxiliary data in a host signal, and in particular to embedding a multibit watermark in the signal and encrypting the associated detection key. Moreover, the invention relates to a method of extracting auxiliary data from a data signal, and in particular to extracting a multibit watermark from the data signal. The invention also relates to a watermark embedder, a watermark detector and to computer readable code.

### BACKGROUND OF THE INVENTION

Digital watermarking has proven an effective deterrent against illegal distribution of copyrighted material in digital form, for instance over computer networks, via electronic content distribution (ECD) applications or via hand-to-hand public distribution.

Watermarking is implemented generally by a pre-coding stage where a watermark is generated and a transcoding watermark embedding stage where the watermark is added to the original data signal in a single or a series of locations within the data signal. Subsequently a watermark detector may extract the watermark from the watermarked data signal in a copyright identification process.

Forensic tracking watermarks are embedded in multimedia content to trace illegally distributed copies. Detecting watermarks in existing multimedia content is potentially a complex operation in terms of computer power. In order to reduce the load of the centralized server and optimise the watermark detection process it would be desirable to perform the detection at the clients-side of a network. However, when distributing the watermark detectors to potentially untrusted clients, there is a risk that the detection key may be stolen or leaked.

In the published US patent application US 2005/0060550 a watermark detection protocol for 1-bit messages is proposed, wherein the watermark key is a scrambled version of the watermark itself, such that knowledge of the watermark key does not imply knowledge of the watermark.

### SUMMARY OF THE INVENTION

The inventors of the present invention have appreciated that a drawback of the prior art is that only 1-bit of information can be embedded in the host signal, rendering it unsuitable for forensic tracking purposes, and have appreciated that an improved means of copyright protection using embedding and/or extraction of multibit watermarks is of benefit, and have in consequence devised the present invention. The present invention seeks to provide an improved means for copyright protection, and preferably, the invention alleviates, mitigates or eliminates one or more disadvantages of the prior art, singly or in any combination.

According to a first aspect of the present invention there is provided a method of embedding auxiliary data in a host signal, the method comprising the steps of:
providing a reference watermark,
generating an encrypted detection key associated with the reference watermark,
generating a multibit watermark by encoding a multibit payload into the reference mark,
embedding the multibit watermark into the host signal.

The invention allows multibit payloads to be embedded in a host signal, where the resulting detection key is encrypted, and thereby in addition to copy-control type applications, also enable forensic tracking of a host signal, since multibit payload is necessary for forensic tracking purposes.

The invention is particularly but not exclusively advantageous since it facilitates distributed forensic watermark detection in a secure and low complex manner, thereby facilitating distributing watermark detection to a potentially untrusted, or even hostile, environment, e.g. by placing watermark detectors in a client device. The watermark detector may securely be placed in a potentially untrusted device since the detection key is encrypted such that knowledge of the watermark detection key does not imply knowledge of the watermark. Moreover, the invention is particularly but not exclusively advantageous for being cost saving, since only little investment may be needed for a detection facility as compared to a centralized solution, since the invention may be implemented in a software module, in an electronic circuit, etc. requiring only little, or even no, additional hardware in the user device. Moreover, the invention may be particularly but not exclusively advantageous for facilitating a high throughput, since compared to a centralized solution, watermark detection may potentially be achieved in more signals, enhancing the overall performance.

The optional feature as defined in claim 2 is advantageous since by providing a multibit payload by adding a cyclically rotated version of the reference watermark to the watermark an efficient way of adding a multibit payload is provided.

The optional feature as defined in claim 3 is advantageous since by using the encryption detection key as a watermark detection key at a device adapted for reading the host signal, local watermark detection at a client device is rendered possible.

The optional feature as defined in claim 4 is advantageous since by encrypting the detection key by scrambling the reference watermark with a scrambling code, a robust and efficient encryption is obtained rendering secure distribution of the detection key possible.

The optional features as defined in claims 5 to 7 are advantageous since they describe important ways of linking the scrambling code to a user of the host signal by associating the scrambling code with a device adapted for reading the host signal, with a user ID, or with a combination of the two.

The optional feature as defined in claim 8 is advantageous since by encoding a user ID in the payload, a user is directly linked to the signal itself.

The optional features as defined in claim 9 are advantageous since they facilitates embedding auxiliary data in one or more possibly overlapping segments of a host signal. This is advantageous since it may only be necessary to embed the watermark in a segment of a host signal, certain segments may exhibit properties which are most suitable for watermark embedding, it may render the embedding process and/or the extraction process even more efficient if only one or more segments are to be considered.

The optional feature as defined in claim 10 is advantageous since a correlation-based watermark detector is a robust and effective watermark detector.

The optional features as defined in claim 11 are advantageous since by applying the constraint that the sum of the product between the scrambling code and the reference watermark and the product between the scrambling code and the multibit watermark is minimized according to a predefined cost function, such as the L₁-distance, the detection performance is optimized.

The optional features as defined in claim 12 disclose advantageous embodiments according to the possible content of the data signal. The data signal may comprise at least one of: audio, video, images, multimedia software, multidimensional graphical models, software structures.

According to a second aspect of the present invention there is provided a method of extracting auxiliary data from a data signal comprising the steps of:
receiving a data signal including a reference watermark and a multibit payload,
providing an encrypted detection key associated with the reference watermark,
extracting based on the encryption detection key the multibit payload from the data signal.

The invention according to the second aspect is particularly but not exclusively advantageous since it facilitates extracting a multibit payload from a data signal, such as a multibit payload being embedded by a method according to the first aspect of the invention. Furthermore, since the detection key is encrypted the extraction may even be performed in a potentially untrusted device.

According to a third and a fourth aspect of the present invention there are provided a watermark embedder comprising:
means for providing a reference watermark,
means for generating an encrypted detection key associated with the reference watermark,
means for generating a multibit watermark by encoding a multibit payload into the reference mark,
means for embedding the multibit watermark into the host signal.
and a watermark detector comprising:
means for receiving a data signal including a reference watermark and a multibit payload,
means for providing an encrypted detection key associated with the reference watermark,
means for extracting based on the encryption detection key the multibit payload from the data signal.

The watermark embedder of the third aspect of the invention is provided in accordance with the method of the first the first aspect of the invention, and the method of the first aspect may be implemented for controlling a watermark embedder of the third third aspect of the invention. The watermark detector of the fourth aspect is provided in accordance with the second aspect of the invention, and the method of the second aspect may be implemented for controlling a watermark detector of the fourth aspect of the invention.

In a fifth aspect of the invention is provided a computer readable code for implementing the method of the first aspect.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 schematically illustrates a strategy for embedding a multibit payload into a host signal according to an embodiment of the invention.

FIG. 2 illustrates a schematic diagram of a watermark embedding process.

FIG. 3 illustrates a schematic diagram of a watermark detection process.

FIG. 4 illustrates a schematic diagram of the payload extraction process according to an embodiment of the invention.

### DESCRIPTION OF EMBODIMENTS

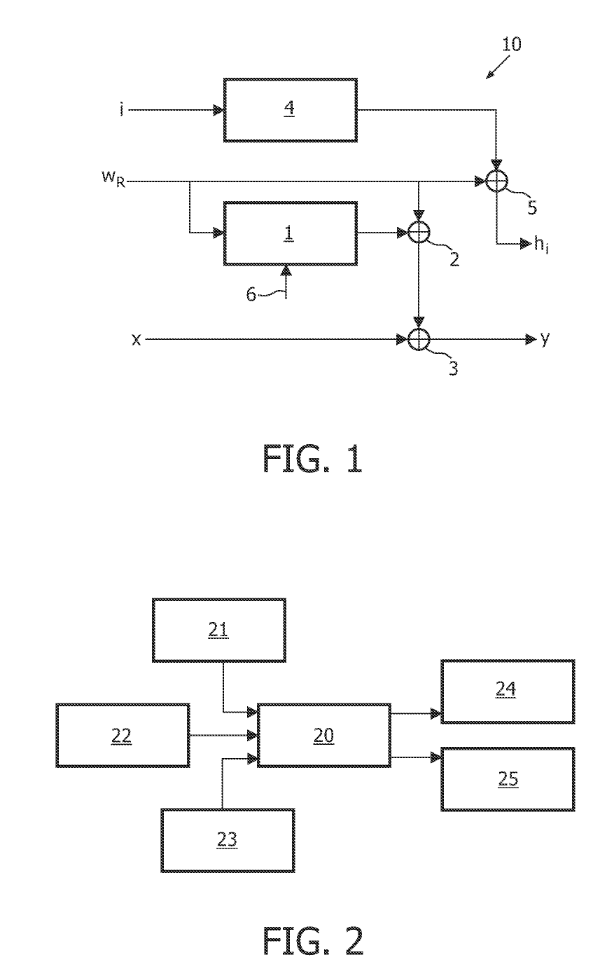

FIG. 1 schematically illustrates a strategy 10 for embedding auxiliary data, here illustrated as a multibit payload, into a host signal x according to an embodiment of the invention. The input of the embedding process comprises an identifier i, a reference watermark W_{R} and the host signal x. The embedding of the auxiliary data may in an embodiment be performed at one or more computer systems performing as watermark embedders or encoders, e.g. computer systems located at a content owner. The output of the embedding process comprises an encryption key hᵢ and the watermarked signal y. The encryption key is then distributed to a user or client either together with, or separate from the watermarked signal y.

The host signal may be a signal to be distributed to a client or a user of the signal. The signal may be distributed via a computer network, via an electronic content distribution (ECD) application, via a record carrier, such as a recordable or ROM optical record carrier or semiconductor or magnetic based carrier, etc. A user of the signal may then render or playback the signal on a device adapted for reading the host signal, such as on a CD-player, a DVD-player, a computer, a portable playback device, a game console, etc.

In a first step a reference watermark w_{R} is provided or determined. The reference watermark may be any suitable type of digital watermark, such as a spatial watermark embedded in the base band of the signal, or a temporal watermark to be detected in the frequency domain. The reference watermark is used for generating 2 a multibit watermark to be embedded in the host signal, and is used for generating 5 an encryption detection key.

A multibit payload w_{P} is encoded 1, the multibit payload may be an n-bit payload, n being any number e.g. depending on a compromise between desired amount of auxiliary data to be embedded and extraction time of the payload, since it may be a requirement that the payload is extracted in real time prior to each playback of the content of the watermarked signal. The payload may be a cyclically rotated version of the reference watermark, such that presence or absence of a cyclically rotated version may represent a bit of the payload. In an embodiment may a user ID 6 or other identifying auxiliary data be encoded into the payload.

The multibit payload w_{P} is then adding to the reference watermark 2 and the resulting mark is added to the host signal 3, so a watermarked signal y is generated:

y=x+(w_{R}+w_{P})

The multibit watermark (w_{R}+w_{P}) may be scaled according to the masking properties of the host signal, i.e. a perceptual mask may be applied to the multibit watermark.

An encryption detection key hᵢ which is associated with the reference watermark is also generated. In an embodiment only the reference watermark is scrambled with a scrambling code cᵢ, and not the part in which the multibit payload is encoded. The scrambling code may be associated with the user ID and/or a device adapted reading the host signal e.g. via the identifier i, e.g. by assigning a scrambling code with the identifier i to a specific user and/or a specific device. The scrambling code may be a randomly generated key. The detection key may be expressed as:

hᵢ=cᵢ\textcircled{+}w_{R}

FIG. 2 illustrates a schematic diagram of a watermark embedding process. An identifier 21, a reference watermark 22 and the host signal 23 are inputted into the watermark embedder 20. The watermark embedder generates and embeds the multibit payload as well as the detection key. The output of the embedding process comprises the encryption key 24 and the watermarked signal 25.

The embedding process may be implemented in a watermark embedder 20 (or encoder) comprising means for providing 22 a reference watermark, such as means for generating or selecting a reference watermark; means for generating 5 an encrypted detection key associated with the reference watermark; means for generating 1 a multibit watermark by encoding a multibit payload into the reference mark; and means for embedding 3 the multibit watermark into the host signal. These means may typically be implemented in separate or a single processing unit, either as a software implementation or as a hardware implementation.

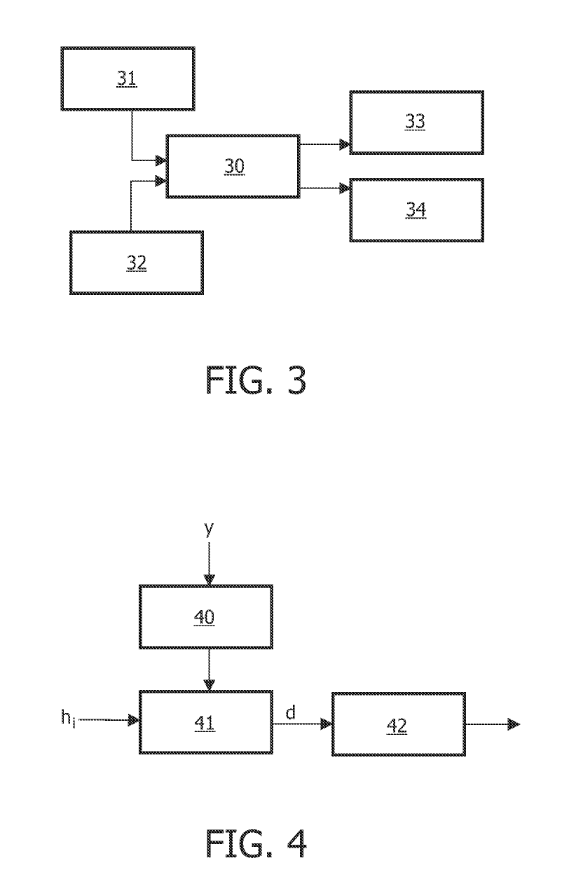

FIG. 3 illustrates a schematic diagram of the watermark detection process. The detection process may be part of a playback seance of the content. The watermark detection may be implemented in the user device for forensic tracking purposes, as well as in a user device where a protocol ensures that playback of the content is only performed if a valid watermark or payload is detected in the signal.

The watermark detector may depend on the type of signal. For watermark detection in video signals, such as MPEG video, the watermark detector may at least partially be a video (MPEG) decoder, whereas for watermark detection in audio signals, such as MP3, the watermark detector may at least partially be an audio (MP3) decoder. The detector may be implemented as a part of the playback device itself or as a part of the playback application.

In an embodiment the watermark detector 30 receives a possible watermarked signal 31 for verification that a watermark is indeed present in the signal, and if so, for extraction of the embedded multibit payload. The watermark detector also receives or has access to the encrypted detection key 32 associated with the watermarked signal. The detection key is associated only with the reference watermark, not the payload.

In an embodiment is the detection of the watermark obtained by a correlation-based watermark detector. Computing the correlation of the signal and the detection key comprises computing the inner product: d=<y, hᵢ> between the signal and the detection key, the correlation is done according to y and hᵢ, since only the scrambled key and the watermarked signal are available, resulting in:

d=<y,hᵢ>=xw_{R}+xcᵢ+w_{R}cᵢ+w_{R}w_{R}+w_{P}w_{R}+w_{P}cᵢ

where a large value of d typically indicates the presence of a watermark.

The output of the watermark detection process may include the signal 33 itself for playback and the multibit payload 34.

It is observed that the detection result includes the distortion components w_{R} cᵢ and w_{P} cᵢ. Therefore the detection performance may be optimized by constraining the scrambling code cᵢ, so that only scrambling codes fulfilling the requirement that (w_{R} cᵢ+w_{P} cᵢ) is minimized.

FIG. 4 illustrates a schematic diagram of the payload extraction process for a correlation based detector according to an embodiment of the invention. The signal y may be pre-processed 40 in a first step. The pre-processing may depend upon the embedding method, the pre-processing may e.g. be a pre-filtering, such as a transformation of the signal to a different domain, e.g. by means of a discrete Fourier transformation, a discrete cosine transformation or the like. The signal is correlated 41 with the detection key hi, and the payload is extracted 42. For example by finding the relative rotation between the reference pattern and the payload sequence.

The watermark detector 30 may comprise means for receiving 31 a data signal including a reference watermark and a multibit payload; means for providing 32 an encrypted detection key associated with the reference watermark; and means for extracting 34 based on the encryption detection key the multibit payload from the data signal. These means may typically be implemented in separate or a single processing unit, either as a software implementation or as a hardware implementation.

All aspects of the invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with preferred embodiments, it is not intended to be limited to the specific form set forth herein. Rather, the scope of the present invention is limited only by the accompanying claims.

Certain specific details of the disclosed embodiment are set forth for purposes of explanation rather than limitation, so as to provide a clear and thorough understanding of the present invention. However, it should be understood by those skilled in this art, that the present invention might be practised in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims, however the inclusion of the reference signs is only for clarity reasons and should not be construed as limiting the scope of the claims.

1. Method of embedding auxiliary data in a host signal, the method comprising the steps of:
providing a reference watermark (w_{R}),
generating an encrypted detection key (hᵢ) associated with the reference watermark,
generating a multibit watermark by encoding (1) a multibit payload (w_{P}) into the reference mark,
embedding (3) the multibit watermark into the host signal (y).

2. Method according to claim 1, wherein the multibit payload is added to the reference watermark by adding a cyclically rotated version of the reference watermark to the watermark.

3. Method according to claim 1, wherein the encryption detection key is used as a watermark detection key at a device adapted for reading the host signal.

4. Method according to claim 1, wherein the detection key is encrypted by scrambling the reference watermark with a scrambling code.

5. Method according to claim 4, wherein the scrambling code is associated with a device adapted for reading the host signal.

6. Method according to claim 4, wherein the scrambling code is associated with a user ID.

7. Method according to claim 4, wherein the scrambling code is associated with both a user ID and a device adapted for reading the host signal.

8. Method according to claim 1, wherein a user ID of the host signal is encoded in the multibit payload.

9. Method according to claim 1, wherein the host signal is segmented into one or more segments and wherein
a segment watermark is provided for at least one of the segments
an encrypted segment key associated with at least one segment watermark is provided
a multibit segment watermark is generated for at least one of the segment watermarks,
embedding the multibit segment watermark into the segment of the host signal.

10. Method according to claim 1, wherein the detection of the watermark is obtained by a correlation-based watermark detector (31).

11. Method according to claim 10, wherein the detection key is encrypted by scrambling the detection key with a scrambling code, and wherein the scrambling code fulfils the constraint that the sum of the product between the scrambling code and the reference watermark and the product between the scrambling code and the multibit watermark is minimized according to a predefined cost function.

12. Method according to claim 1, wherein the host signal comprises at least one of: audio, video, images, multimedia software, multidimensional graphical model, software structure.

13. Method of extracting auxiliary data from a data signal comprising the steps of:
receiving a data signal including a reference watermark and a multibit payload (w_{P}),
providing an encrypted detection key (hᵢ) associated with the reference watermark (w_{R}),
extracting based on the encryption detection key the multibit payload from the data signal (y).

14. Watermark embedder (20) comprising:
means for providing (22) a reference watermark (w_{R}),
means for generating (5) an encrypted detection key (hᵢ) associated with the reference watermark,
means for generating (1) a multibit watermark by encoding a multibit payload (w_{P}) into the reference mark,
means for embedding (3) the multibit watermark into the host signal (x).

15. Watermark detector (30) comprising:
means for receiving (31) a data signal including a reference watermark and a multibit payload,
means for providing (32) an encrypted detection key associated with the reference watermark,
means for extracting (34) based on the encryption detection key the multibit payload from the data signal (y).

16. Computer readable code for implementing the method of claim 1.
